(19) United States
(12) Patent Application Publication
(10) Pub. No.: US 2026/0177016 A1
(43) Pub. Date: Jun. 25, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventors: Akihiko HIGUCHI, Nagoya-shi (JP); Masanori TOYA, Inazawa-shi (JP); Tatsuhiko NAGASHIMA, Toyoake-shi (JP); Taketo NAGASAKI, Nagakute-shi (JP); Ken AYUKAWA, Nagoya-shi (JP)

(73) Assignee: TOYOTA JIDOSHA KABUSHIKI KAISHA, Toyota-shi (JP)

(21) Appl. No.: 19/394,051

(22) Filed: Nov. 19, 2025

(30) Foreign Application Priority Data
Dec. 24, 2024 (JP) 2024-227418

(51) Int. Cl. F02D 41/40; F02D 41/00

(52) U.S. Cl. CPC F02D 41/401; F02D 41/009; F02D 41/0097

(57) ABSTRACT

A control device controls an engine including an injector that injects hydrogen as fuel. In the engine controlled by the control device, an insertion hole having a fuel injection hole connected to a cylinder at a bottom is provided in a cylinder head. In the engine controlled by the control device, a sac chamber is provided between a tip end of the injector in a state of being inserted into the insertion hole and the bottom of the insertion hole. The control device includes a processing circuit. The processing circuit advances a fuel injection end timing indicated by a crank angle as an engine rotation speed increases.

### CROSS-REFERENCE TO RELATED APPLICATION

This application claims priority to Japanese Patent Application No. 2024-227418 filed on Dec. 24, 2024. The disclosure of the above-identified application, including the specification, drawings, and claims, is incorporated by reference herein in its entirety.

### BACKGROUND

### 1. Technical Field

The present disclosure relates to a control device for an internal combustion engine.

### 2. Description of Related Art

Japanese Unexamined Patent Application Publication No. 2011-047281 (JP 2011-047281 A) discloses a control device for a hydrogen engine that suppresses a continuous occurrence of pre-ignition during intake strokes. The control device for the hydrogen engine suppresses the continuous occurrence of pre-ignition by correcting the air-fuel ratio to a lean side each time the occurrence of pre-ignition is detected.

### SUMMARY

The control device for the hydrogen engine suppresses the occurrence of further consecutive pre-ignition after the occurrence of pre-ignition. However, the control device for the hydrogen engine cannot suppress the occurrence of pre-ignition itself.

A control device for an internal combustion engine, for solving the issue described above, controls the internal combustion engine including an injection device that injects hydrogen as fuel. The internal combustion engine controlled by the control device for the internal combustion engine has an insertion hole in a cylinder head. The insertion hole has a fuel injection hole connected to the inside of a cylinder at a bottom. The internal combustion engine controlled by the control device for the internal combustion engine is provided with a sac chamber between a tip end of the injection device in a state of being disposed in the insertion hole and the bottom of the insertion hole. The control device for the internal combustion engine includes a processing circuit. The processing circuit of the control device for the internal combustion engine advances a fuel injection end timing indicated by a crank angle as an engine rotation speed increases.

With the control device for the internal combustion engine, the occurrence of pre-ignition due to hydrogen remaining in the sac chamber can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a control device of an embodiment and a configuration of an engine that is a control target of the control device;

FIG. 2 is an enlarged view of a portion surrounded by a one-dot chain line shown in FIG. 1;

FIG. 3 is a flowchart showing a process when the processing circuit of the control device shown in FIG. 1 controls fuel injection in the engine;

FIG. 4 is a schematic diagram showing a relationship between the fuel injection end timing and the engine rotation speed when the processing circuit sets the fuel injection end timing in the process shown in FIG. 3; and

FIG. 5 is a schematic diagram showing a relationship between the fuel injection period set by the processing circuit and the engine rotation speed in the process shown in FIG. 3.

### DETAILED DESCRIPTION OF EMBODIMENTS

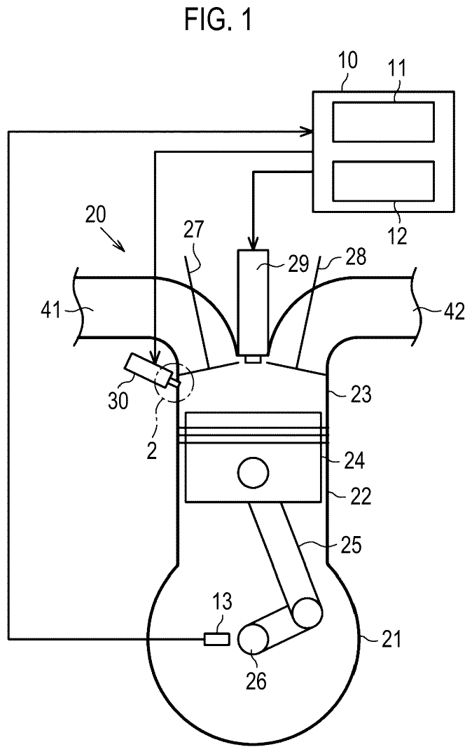

Hereinafter, a control device 10 that is an embodiment of a control device for an internal combustion engine will be described with reference to FIGS. 1 to 5. FIG. 1 shows a configuration of an engine 20 that is a control target of a control device 10 and the control device 10.

### Configuration of Control Device 10

As shown in FIG. 1, the control device 10 includes a processing circuit 11 and a storage device 12. The processing circuit 11 includes a CPU that executes processing in accordance with a program and a ROM in which the program is stored. The storage device 12 includes a non-volatile memory that records data related to the engine 20.

The control device 10 is, for example, one of control devices built in an engine electronic control unit (ECU) that controls the engine 20. The control device 10 controls fuel injection and ignition in the engine 20.

### Configuration of Engine 20

As shown in FIG. 1, the engine 20 is a hydrogen engine including a plurality of cylinders 22. The engine 20 is mounted on a vehicle. Each cylinder 22 constitutes a combustion chamber that burns an air-fuel mixture of fuel and intake air. The fuel in the engine 20 is hydrogen.

The engine 20 includes a crank case 21, each cylinder 22, a cylinder head 23, an intake passage 41, and an exhaust passage 42. Inside each cylinder 22, a piston 24 and a connecting rod 25 are housed. The connecting rod 25 is connected to a crankshaft 26 housed in the crank case 21.

A cylinder head 23 is attached to an upper portion of each cylinder 22. Each cylinder 22 and the cylinder head 23 constitute a combustion chamber in each cylinder 22. The cylinder head 23 includes an intake valve 27, an exhaust valve 28, an ignition device 29, and an injector 30. The ignition device 29 and the injector 30 are connected to the control device 10, respectively. The processing circuit 11 of the control device 10 controls the ignition device 29 and the injector 30 to control the fuel injection and the ignition in the engine 20.

An intake passage 41 and an exhaust passage 42 that communicate with each combustion chamber are connected to the cylinder head 23, respectively. The intake passage 41 is a passage that guides the intake from the outside to each combustion chamber. A downstream end of the intake passage 41 communicates with each combustion chamber. An intake valve 27 is provided in the end portion. An opening portion of the intake passage 41 to the combustion chamber is opened and closed by the intake valve 27.

The exhaust passage 42 is a passage that guides the exhaust from each cylinder 22 to an exhaust system component. An upstream end of the exhaust passage 42 communicates with each combustion chamber. An exhaust valve 28 is provided in the end portion. An opening portion of the exhaust passage 42 to the combustion chamber is opened and closed by the exhaust valve 28.

The engine 20 is provided with a crank angle sensor 13. The crank angle sensor 13 is connected to the control device 10. The processing circuit 11 acquires a crank angle (CA) that is a rotation angle of the crankshaft 26 based on an input from the crank angle sensor 13. The processing circuit 11 controls the fuel injection and the ignition timing based on the crank angle. The crank angle is expressed based on a top dead center (TDC). The side advanced from the TDC is before top dead center (BTDC). The side delayed from the TDC is after top dead center (ATDC). The processing circuit 11 sets the fuel injection start timing, the fuel injection end timing, or the ignition timing by using the crank angle. For example, in a case where the processing circuit 11 sets the fuel injection start timing to BTDC 60° CA, the fuel injection is started when the crank angle in the target cylinder 22 becomes BTDC 60° CA. For example, in a case where the processing circuit 11 sets the fuel injection end timing to BTDC 30° CA, the fuel injection is ended when the crank angle in the target cylinder 22 becomes BTDC 30° CA.

In addition, the processing circuit 11 calculates the engine rotation speed that is the rotation speed of the output shaft of the engine 20 by using the data of the crank angle acquired based on the input from the crank angle sensor 13. The processing circuit 11 calculates the engine rotation speed based on, for example, a time needed for the crank angle to change by a predetermined amount.

### Configuration of Injector 30

As shown in FIG. 1, an injector 30 that is an injection device for injecting hydrogen is provided on the intake passage 41 side of the cylinder head 23. The engine 20 is a direct injection type hydrogen engine.

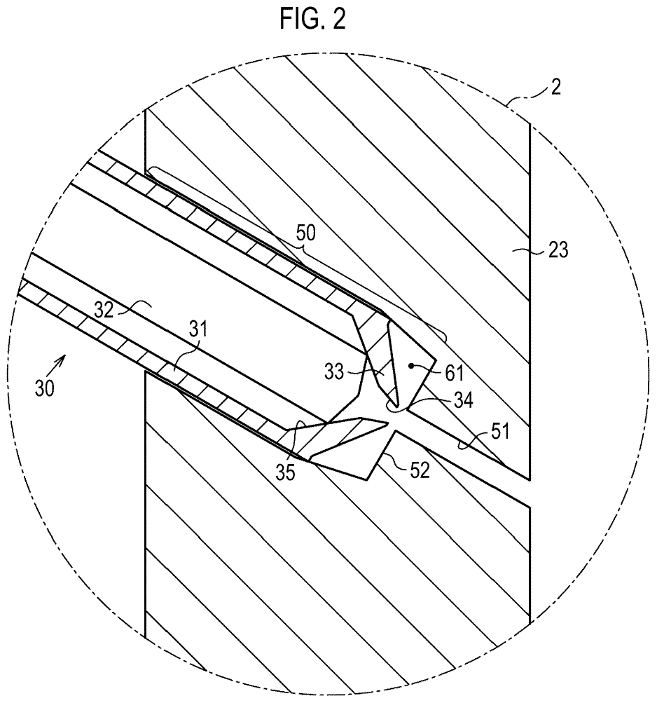

FIG. 2 is an enlarged view of a portion surrounded by a circle 2 with one-dot chain line shown in FIG. 1. FIG. 2 is a portion in which the injector 30 is inserted into an insertion hole 50 provided in the cylinder head 23. In FIG. 2, a right side of the cylinder head 23 is a combustion chamber.

As shown in FIG. 2, the insertion hole 50 is provided in the cylinder head 23 to be obliquely directed toward the combustion chamber side. A fuel injection hole 51 is provided at a bottom 52 of the insertion hole 50. The fuel injection hole 51 communicates from the bottom 52 of the insertion hole 50 to a combustion chamber in the cylinder 22.

The injector 30 is inserted into the insertion hole 50. The injector 30 includes a housing 31 and a needle 32. The housing 31 and the needle 32 have a substantially cylindrical shape. The needle 32 is housed inside the housing 31. A valve seat portion 33 is provided at a tip end of the housing 31. The housing 31 is in contact with the needle 32 by a valve seat surface 35 provided in the valve seat portion 33. The port 34 is an opening portion provided in the valve seat portion 33. A space inside the housing 31 communicates with the insertion hole 50 via the port 34.

As shown in FIG. 2, a space is provided between the tip end of the injector 30 and the bottom 52 of the insertion hole 50 inside the insertion hole 50. The space is referred to as a sac chamber 61.

The fuel at a high pressure is supplied to the injector 30 from a fuel tank that stores hydrogen through a fuel supply path. The hydrogen supplied to the injector 30 flows through a space between the housing 31 and the needle 32 and is injected from the port 34. The injector 30 controls the injection of hydrogen into the cylinder 22 by a valve mechanism constituted by the housing 31 and the needle 32.

A coil spring (not shown) is housed in the housing 31. The coil spring is housed in the housing 31 in a state where a spring portion is compressed from a free length. The tip end of the needle 32 is pressed against the valve seat surface 35 by a restoring force of the compressed coil spring. As described above, when the needle 32 is in a state of being pressed against the valve seat surface 35, the valve mechanism of the injector 30 is in a valve-closed state. A state in which the needle 32 is pressed against the valve seat surface 35 is expressed as a state in which the needle 32 is seated. That is, when the needle 32 is seated, the hydrogen is not injected from the injector 30.

A solenoid (not shown) is housed in the housing 31. The solenoid is provided with an electromagnet that generates a magnetic field by being energized. The needle 32 is pulled away from the valve seat surface 35 by the electromagnetic force toward the side of the housing 31 opposite to the tip end of the needle 32. As described above, when the needle 32 is pulled away from the valve seat surface 35, the valve mechanism of the injector 30 is in a valve-open state. That is, when the needle 32 is not seated, the hydrogen is injected from the injector 30.

The hydrogen injected from the injector 30 diffuses and fills the sac chamber 61, and flows into the cylinder 22 through the fuel injection hole 51. The hydrogen that diffuses, fills, and remains in the sac chamber 61 also moves to the cylinder 22 as time passes.

### Control of Fuel Injection

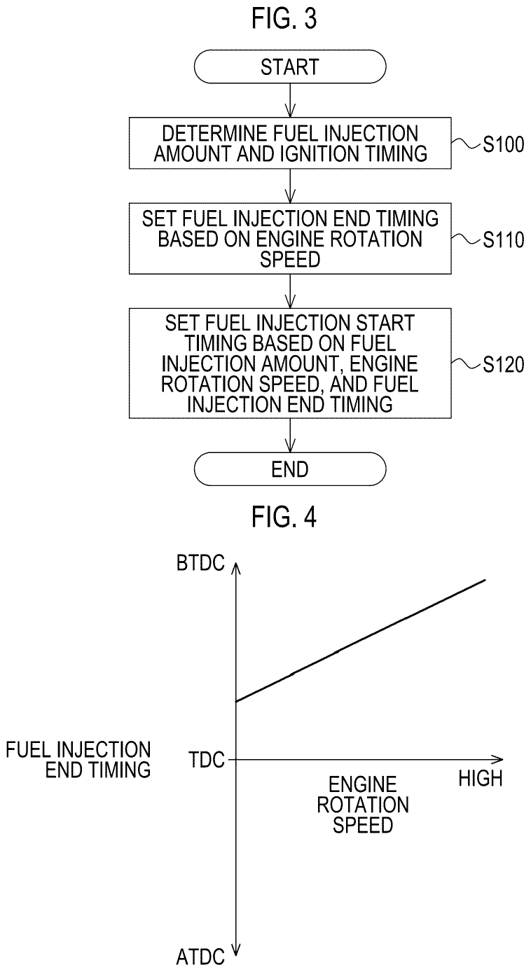

FIG. 3 is a flowchart showing a process when the processing circuit 11 of the control device 10 controls fuel injection in each cylinder 22 of the engine 20. The processing circuit 11 executes the process shown in FIG. 3 for each combustion cycle in each cylinder 22.

As shown in FIG. 3, in S100, the processing circuit 11 determines the fuel injection amount and the ignition timing in the next combustion. The processing circuit 11 calculates the fuel injection amount in response to a request torque determined based on a traveling state of a vehicle on which the engine 20 is mounted. The request torque is determined based on, for example, a vehicle speed, an accelerator operation amount, and an engine rotation speed. In general, when the request torque of the vehicle is large, the fuel injection amount is increased.

Further, the processing circuit 11 determines the ignition timing based on the fuel injection amount and the traveling state of the vehicle on which the engine 20 is mounted. The determined ignition timing is indicated by the crank angle as described above. When the fuel injection amount and the ignition timing are determined, the processing circuit 11 proceeds to S110 with the process.

In S110, the processing circuit 11 sets the fuel injection end timing based on the engine rotation speed. The fuel injection end timing is a time when the processing circuit 11 controls the needle 32 of the injector 30 to be seated on the valve seat surface 35, thereby closing the valve mechanism of the injector 30. The processing circuit 11 sets the fuel injection end timing based on the fuel injection amount, the engine rotation speed, the ignition timing, and the like.

FIG. 4 is a schematic diagram showing a relationship between the engine rotation speed and the fuel injection end timing when the processing circuit 11 sets the fuel injection end timing based on the engine rotation speed. A horizontal axis of FIG. 4 indicates an engine rotation speed. A vertical axis of FIG. 4 indicates a fuel injection end timing indicated by a crank angle.

As shown in FIG. 4, the fuel injection end timing is set to a more advanced side as the engine rotation speed increases. That is, the processing circuit 11 sets the fuel injection end timing to be more advanced as the engine rotation speed increases. When the fuel injection end timing is set, the processing circuit 11 proceeds to S120 shown in FIG. 3 with the process.

In S120, the processing circuit 11 sets the fuel injection start timing. In this case, the processing circuit 11 sets the fuel injection start timing based on the engine rotation speed, the fuel injection amount determined in S100, and the fuel injection end timing determined in S110. Specifically, the fuel injection start timing is set such that a fuel injection period during which hydrogen can be injected for the fuel injection amount determined in S100 is secured until the fuel injection end timing arrives. The fuel injection period is a time from the fuel injection start timing to the fuel injection end timing. The fuel injection start timing is a time when the processing circuit 11 controls the needle 32 of the injector 30 to be pulled away from the valve seat surface 35, thereby opening the valve mechanism of the injector 30.

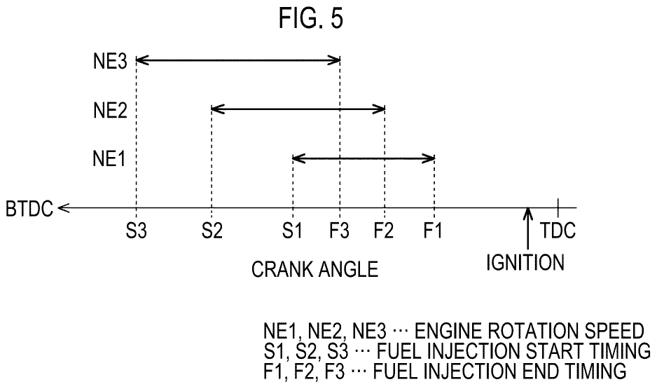

FIG. 5 is a schematic diagram showing a relationship between the engine rotation speed and the fuel injection period when the processing circuit 11 sets the fuel injection start timing based on the engine rotation speed. A horizontal axis of FIG. 5 indicates a crank angle.

NE1, NE2, and NE3 respectively indicate engine rotation speeds. In NE1, NE2, and NE3, both arrows indicate a fuel injection period indicated by the crank angle at each engine rotation speed. The engine rotation speed is increased in the order of NE1, NE2, NE3. That is, both arrows in NE3 indicate the fuel injection period when the engine rotation speed is the highest among the three.

F1, F2, and F3 respectively indicate fuel injection end timings at the engine rotation speeds of NE1, NE2, and NE3. The fuel injection end timing is set to the more advanced side in the order of F1, F2, F3. The fuel injection end timing is set to the more advanced side as the engine rotation speed increases, consistent with the relationship shown in FIG. 4.

S1, S2, and S3 respectively indicate fuel injection start timings at the engine rotation speeds of NE1, NE2, and NE3. The fuel injection start timing is set to the more advanced side in the order of S1, S2, S3. That is, the processing circuit 11 advances the fuel injection start timing as the engine rotation speed increases.

The ignition timing at each of the engine rotation speeds of NE1, NE2, and NE3 is the same.

In S120 of FIG. 3, the processing circuit 11 sets the fuel injection start timing such that a fuel injection period during which the hydrogen can be injected for the fuel injection amount determined in S100 is secured. Therefore, as shown in FIG. 5, the fuel injection period indicated by the crank angle is longer as the engine rotation speed increases.

In a case where the fuel injection start timing is advanced by the same amount as the fuel injection end timing is advanced in S110 in S120, the fuel injection period is shorter as the engine rotation speed increases. Therefore, when the fuel injection end timing is advanced depending on the engine rotation speed, the processing circuit 11 sets the fuel injection start timing such that the fuel injection period is secured in S120 by increasing the fuel injection start timing larger than the fuel injection end timing.

When the process of S120 is completed, the processing circuit 11 completes the process shown in FIG. 3.

In the process shown in FIG. 3, the processing circuit 11 defines the fuel injection start timing and the fuel injection end timing by using the crank angle. The processing circuit 11 advances the fuel injection end timing as the engine rotation speed increases, and advances the fuel injection start timing as the engine rotation speed increases.

### Operation of Present Embodiment

The hydrogen injected from the injector 30 is injected into the cylinder 22 through the fuel injection hole 51. When the hydrogen remaining in the sac chamber 61 continues to react with oxygen without being completely burned in a combustion stroke, the sac chamber 61 and the vicinity of the sac chamber 61 are maintained at a high temperature. In this state, when the hydrogen is newly injected from the injector 30, the hydrogen is ignited at a high temperature portion in the sac chamber 61 or around the sac chamber 61, and pre-ignition occurs.

Even when the fuel injection end timing indicated by the crank angle is the same, the time from the fuel injection end timing to the ignition timing is shorter as the engine rotation speed increases.

The processing circuit 11 of the control device 10 ensures a time for diffusing the hydrogen staying in the sac chamber 61 into the cylinder 22 until the ignition timing by advancing the fuel injection end timing as the engine rotation speed increases. In this way, the processing circuit 11 suppresses the hydrogen remaining in the sac chamber 61 after the combustion stroke from continuously reacting with oxygen.

### Effect of Embodiment

(1) With the control device 10, the occurrence of pre-ignition due to the hydrogen remaining in the sac chamber 61 can be suppressed.

(2) The processing circuit 11 advances the fuel injection end timing as the engine rotation speed increases, and advances the fuel injection start timing indicated by the crank angle as the engine rotation speed increases.

With the control device 10, a fuel injection period for injecting a needed amount of fuel can be secured.

(3) In a case where the fuel injection start timing is advanced by the same amount as the fuel injection end timing is advanced, the fuel injection period is shorter as the engine rotation speed increases.

Therefore, when the fuel injection end timing is advanced depending on the engine rotation speed, the processing circuit 11 advances the fuel injection start timing larger than the fuel injection end timing. As a result, the fuel injection period can be suppressed from being short and the injection amount of hydrogen can be suppressed from being insufficient.

(4) The processing circuit 11 sets the fuel injection start timing such that the fuel injection period is secured when the fuel injection end timing is advanced depending on the engine rotation speed.

The processing circuit 11 advances the fuel injection start timing and the fuel injection end timing while keeping the fuel injection period constant.

With the control device 10, the fuel injection amount can be maintained even when the fuel injection end timing is advanced.

### Modification

The present embodiment can be modified and carried out as follows. The present embodiment and the following modifications can be carried out in combination within a technically consistent range.
The processing circuit 11 may not set the fuel injection start timing to secure the fuel injection period. The processing circuit 11 may increase a change amount of the crank angle when the fuel injection start timing is advanced, as compared with a change amount of the crank angle when the fuel injection end timing is advanced. In this case, the processing circuit 11 can suppress the decrease in the fuel injection amount as compared with a case where the fuel injection start timing is advanced by the same amount as the fuel injection end timing.
In addition, the injection pressure of hydrogen from the injector 30 can be increased to suppress the decrease in the fuel injection amount. Even when the fuel injection period from the fuel injection start timing to the fuel injection end timing is shortened due to an increase in the engine rotation speed, the amount of hydrogen injected per unit time is increased. Therefore, the processing circuit 11 can maintain the fuel injection amount constant by increasing the injection pressure of hydrogen from the injector 30 in response to the shortening of the fuel injection period, even when the advancement amount of the fuel injection start timing is small.
In addition, the processing circuit 11 may not advance the fuel injection start timing when the fuel injection end timing is advanced. The processing circuit 11 may advance solely the fuel injection end timing. Even in this case, the injection pressure of the fuel can be increased to suppress the insufficient fuel injection amount due to the shortening of the fuel injection period as the engine rotation speed increases.
The relationship between the engine rotation speed and the fuel injection end timing when the processing circuit 11 sets the fuel injection end timing based on the engine rotation speed is not limited to that shown in FIG. 4. The relationship between the engine rotation speed and the fuel injection end timing may not be a linear relationship as shown in FIG. 4. The relationship may be that the inclination of the straight line is changed in the middle as long as the fuel injection end timing is advanced as the engine rotation speed increases. The relationship may be a curved relationship.
The processing circuit 11 keeps the ignition timing the same regardless of the engine rotation speed. The processing circuit 11 may change the ignition timing within a range in which a time for diffusing the hydrogen staying in the sac chamber 61 into the cylinder 22 until the ignition timing can be secured. For example, the processing circuit 11 may advance the ignition timing within a range in which a diffusion time of hydrogen can be secured.

What is claimed is:

1. A control device for an internal combustion engine, the control device controlling the internal combustion engine, the internal combustion engine including an injection device that injects hydrogen as fuel, the internal combustion engine having an insertion hole in a cylinder head, the insertion hole having a fuel injection hole connected to inside of a cylinder at a bottom, the internal combustion engine being provided with a sac chamber between a tip end of the injection device in a state of being disposed in the insertion hole and the bottom of the insertion hole, the control device comprising a processing circuit,
wherein the processing circuit advances a fuel injection end timing indicated by a crank angle as an engine rotation speed increases.

2. The control device according to claim 1, wherein the processing circuit advances the fuel injection end timing as the engine rotation speed increases, and advances a fuel injection start timing indicated by the crank angle as the engine rotation speed increases.

3. The control device according to claim 2, wherein the processing circuit advances the fuel injection start timing larger than the fuel injection end timing in a case where the fuel injection end timing is advanced depending on the engine rotation speed.

4. The control device according to claim 3, wherein the processing circuit sets the fuel injection start timing such that a fuel injection period is secured in the case where the fuel injection end timing is advanced depending on the engine rotation speed.
